(19) United States
(12) Patent Application Publication
(10) Pub. No.: US 2016/0019782 A1
(43) Pub. Date: Jan. 21, 2016

(54) DEVICE AND METHOD FOR INCREASING ROAD SAFETY IN VEHICLE PLATOONS

(71) Applicant: SCANIA CV AB, Södertälje (SE)

(72) Inventors: Assad ALAM, Enskededalen (SE); Marek SOKALLA, Sodertalje (SE)

(21) Appl. No.: 14/771,559

(22) PCT Filed: Feb. 27, 2014
(86) PCT No.: PCT/SE2014/050241

§ 371 Date: Aug. 31, 2015

(30) Foreign Application Priority Data
Mar. 6, 2013 (SE) 1350267-9

(51) Int. Cl. G08G 1/01; G05D 1/02

(52) U.S. Cl. CPC G08G 1/01; G05D 1/0287

(57) ABSTRACT

A method for increasing road safety in vehicle platoons, including presenting (s401) to vehicles not part of the vehicle platoon, based on information known to the vehicle platoon, information intended to increase road safety. Also a computer program product including program code (P) for a computer (200; 210) to implement a method according to the invention. Also a device for increased road safety in vehicle platoons and a motor vehicle equipped with such a device.

### CROSS-REFERENCE TO RELATED APPLICATIONS

The present application is a 35 U.S.C. §§371 national phase conversion of PCT/SE2014/050241, filed Feb. 27, 2014, which claims priority of Swedish Patent Application No. 1350267-9, filed Mar. 6, 2013, the contents of which are incorporated by reference herein. The PCT International Application was published in the English language.

### TECHNICAL FIELD OF THE INVENTION

The present invention pertains to a method for increasing road safety in vehicle platoons, and also to a computer program product, comprising program code for a computer, to implement a method according to the invention. The invention also pertains to a device for increased road safety in vehicle platoons, and a motor vehicle equipped with such a device.

### BACKGROUND OF THE INVENTION

In vehicles today the air resistance when travelling is a factor which impacts fuel consumption, in particular in e.g. trucks or other relatively large vehicles which have a large front area.

The air resistance of a subsequent vehicle depends to a great extent on its distance to the vehicle in front. In principle, the smaller the distance to a vehicle in front, the less air resistance exists for the following vehicle, and thus the fuel consumption of the subsequent vehicle may be reduced. In cases where two or more vehicles are arranged in a so-called vehicle platoon, i.e. where the subsequent vehicle is driven relatively close to the vehicle in front, the fuel consumption of the subsequent vehicles may be reduced by e.g. 5-15%. Driving vehicles in vehicle platoons may thus reduce fuel costs considerably.

One disadvantage of driving vehicles, such as trucks with trailers, in vehicle platoon formations is that it may cause disruptions in the traffic. Drivers of vehicles which are not part of the vehicle platoon formation may experience difficulties and inconvenience, such as that they may not access to traffic information in the form of e.g. road signs because said vehicle platoon may partly obstruct vision. For drivers of vehicles which do not form part of vehicle platoons, this may also cause inconveniences in assessing the suitability of initiation and completion of overtaking a vehicle platoon. Vehicle platoons may in some cases be several hundreds of meters long, and thus it may be hard for other drivers to make decisions about overtaking the vehicle platoon, for example.

US 2006225329 describes an indication system regarding vehicle status, for installation in a vehicle forming part of a vehicle platoon.

US 2002070849 describes a signalling system for vehicles driven in vehicle platoons, where messages are communicated between vehicles forming part of the vehicle platoon.

### SUMMARY OF THE INVENTION

One objective of this invention is to provide a novel and advantageous method for the improvement of road safety when vehicle platoons are on the road.

Another objective of the invention is to provide a novel and advantageous device and a novel and advantageous computer program for the improvement of road safety in vehicle platoons.

Another objective of the invention is to provide a method, a device and a computer program to achieve improved traffic awareness in drivers of vehicles which do not form part of vehicle platoons.

Yet another objective of the invention is to provide an alternative method, an alternative device and an alternative computer program for improved road safety in vehicle platoons.

According to one aspect of the invention, a method for improved road safety in vehicle platoons comprising the step of:
presenting information, based on information known to the vehicle platoon, intended to increase the road safety for vehicles which do not form part of the vehicle platoon.

The method according to the invention may also entail that traffic in connection with the vehicle platoon may be optimised or improved, e.g. with respect to accessibility and safety.

Said presented information may comprise at least one of the phenomena of vehicle platoon characteristics, vehicle ambient conditions, and including the traffic situation.

One advantage of the present invention is that presented information may comprise information regarding existing road signs, moving animals and other fixed or moveable objects, the road, the area in front of a leader vehicle of the vehicle platoon, areas outside the road, road works, pedestrians, cyclists or potential lane changes which the vehicles ahead in the vehicle platoon intend to make. On presentation of said information, a driver in a vehicle which does not form part of said vehicle platoon may get an increased understanding of a prevailing or future traffic situation.

Said presented information may comprise instructions to vehicles which do not form part of said vehicle platoon.

The method may comprise the step of:
providing signal devices in the vehicle platoon in order to present said information via light and/or audio and/or text messages and/or symbols.

The method may comprise the step of:
communicating information wirelessly for presentation to vehicles which do not form part of the vehicle platoon.

The information presented may comprise a time specification regarding an estimated period of time to overtake the vehicle platoon.

The information presented may comprise a distance specification regarding an estimated distance to overtake the vehicle platoon. The length of the vehicle platoon may also be specified. Alternatively, a total overtaking distance may be specified.

Said information may comprise advice regarding whether or not to overtake the vehicle platoon.

Thus, an improved picture of the surroundings for a driver of a vehicle which does not form part of said vehicle platoon is achieved. The method also entails that a driver of a vehicle which does not form part of said vehicle platoon may obtain an improved understanding of the prevailing traffic situation and also of a future traffic situation.

According to one example, route information may be communicated over a distance of up to 1 km, so that drivers in subsequent vehicles may connect to the wireless communication before the subsequent vehicle reaches a vehicle ahead where forward visibility is limited. Further, a plurality of subsequent vehicles may thus form part of a vehicle platoon and still obtain route information from a vehicle which is first in said vehicle platoon. Thus, a first vehicle in the vehicle platoon may communicate directly with a number of subsequent vehicles, so that unnecessary delays in the transfer of route information are avoided.

The method can handle short delays regarding transferred information. The method is also easy and cheap to install in vehicles.

According to one embodiment, information regarding a prevailing position of vehicles ahead is also transferred to one or several subsequent vehicles. This may take place at the same time as said route information is transferred from a vehicle ahead to a subsequent vehicle. Said position information may be transmitted continuously or intermittently. Said position information may be determined with a GPS device.

According to one embodiment, information about how a vehicle ahead wishes to regulate its speed is transmitted to one or several subsequent vehicles. This may take place at the same time as said route information is transferred from a vehicle ahead to a subsequent vehicle. Said speed information may be transferred continuously or intermittently. Thus, a control system of a subsequent vehicle may obtain information about how a vehicle ahead will behave in the future, as regards e.g. retardation or acceleration.

One advantage of the present invention is that said route information may comprise information regarding existing road signs, moving animals and other fixed or moveable objects, the road, the area in front of the vehicle ahead, areas outside the road, road works, pedestrians, cyclists or potential lane changes made by the vehicles ahead. Thus a driver in a vehicle behind may obtain an increased understanding of a prevailing or future traffic situation.

The method may comprise the step of determining ambient conditions. Said ambient conditions may comprise at least one of the parameters traffic situation including risk elements, road characteristics, climate characteristics and road signs. Thus, a versatile method is provided where different parameters may be presented to a vehicle which does not form part of said vehicle platoon.

Detection of said ambient conditions may take place via suitable elements in a leader vehicle of the vehicle platoon. Detection of said ambient conditions may take place via suitable elements in a suitable vehicle of the vehicle platoon. Said ambient conditions may be communicated in a suitable manner among the vehicles forming part of the vehicle platoon.

The method may comprise the step to determine driving characteristics for said vehicle platoon. The method may comprise the step determining driving characteristics for a leader vehicle of said vehicle platoon.

Said driving characteristics may comprise at least one of the parameters speed, speed changes, direction of travel and planned changes to the direction of travel relating to said leader vehicle and/or vehicle platoon. Said driving characteristics may comprise at least one of the parameters future intended speed and future intended speed changes in relation to said leader vehicle and/or vehicle platoon.

The method may comprise the step of:
determining instructions for presentation to vehicles which do not form part of said vehicle platoon, on the basis of said ambient conditions and/or said driving characteristics. Said determination may take place in real time, continuously or intermittently. Thus, a safe method for safe driving of vehicles which do not form part of said vehicle platoon is obtained. Thus, a user-friendly method for safe driving of vehicles that do not form part of said vehicle platoon is obtained.

The method is easy to implement in existing motor vehicles. Program code for increased road safety in vehicle platoons according to the invention may be installed in a control device of the vehicle during manufacture of the same. A purchaser of the vehicle may thus be afforded the opportunity to select the performance function as an extra option. Alternatively, software comprising program code to perform the innovative method may be installed in a control device of the vehicle, when upgraded at a service station. In this case, the software may be uploaded into a memory in the control device. Implementation of the innovative method is also cost-effective.

According to one aspect of the present invention, a device for increased road safety of vehicle platoons is provided. The device comprises elements adapted to present information, based on information known to the vehicle platoon, intended to increase said road safety to vehicles which do not form part of the vehicle platoon.

The device may comprise:
elements adapted to determine at least one of the phenomena vehicle characteristics and the ambient conditions of the vehicle, including traffic situation, so that said presented information comprises information regarding at least one of the said phenomena vehicle platoon characteristics and the ambient conditions of the vehicle, including traffic situation.

The device may comprise:
elements adapted to determine instructions to vehicles which do not form part of said vehicle platoon, where said presented information comprises information regarding said instructions to said vehicles which do not form part of said vehicle platoon.

The device may comprise:
signal devices in the vehicle platoon, adapted to present said information via light and/or audio and/or text messages and/or symbols.

The device may comprise:
elements adapted to communicate information wirelessly for presentation to vehicles which do not form part of the vehicle platoon.

The device may comprise:
elements adapted to determine time specifications regarding an estimated period of time for overtaking the vehicle, where the thus presented information comprises information regarding said time specification with regard to an estimated period of time to overtake the vehicle platoon.

The device may comprise:
elements adapted to determine a distance specification regarding an estimated distance to overtake the vehicle platoon.

The device may comprise:
elements adapted to determine advice regarding whether or not to overtake the vehicle platoon, where said information comprises information about said advice regarding whether or not to overtake the vehicle platoon.

According to one aspect of the invention, a simple retrofitting of said device may be carried out. Existing vehicles may thus be upgraded quickly and relatively cheaply. The required program code may easily be installed in a control device of the vehicle and/or a portable computer which may be connected to a network in the vehicle.

The above objectives are also achieved with a motor vehicle which comprises the innovative device for increased road safety of vehicle platoons. The motor vehicle may be a truck, a bus or a car.

According to one aspect of the invention, a computer program is provided for improved road safety in a vehicle platoon, wherein said computer program comprises program code stored in a non-transitory computer-readable medium, in order to cause an electronic control device or another computer, connected to the electronic control device, to perform the steps according to the method.

According to one aspect of the invention, a computer program is provided for increased road safety in a vehicle platoon, wherein said computer program comprises program code to cause an electronic control device or another computer, connected to the electronic control device, to perform the steps according to the method.

According to one aspect of the invention, a computer program product, comprising program code stored in a non-transitory computer-readable medium, is provided to perform the method steps according to the disclosure herein, when said program code is executed in an electronic control device or in another computer connected to the electronic control device.

Program code to transfer route information may easily be updated or replaced. Further, different parts of the program code for transfer of vehicle platoon characteristics, the ambient conditions of the vehicle, including the traffic situation, may be replaced independently of each other. Further, different parts of the program code for presenting relevant information to operators of vehicles which do not form part of said vehicle platoon may be replaced independently of each other. This modular configuration is advantageous from a maintenance perspective.

Additional objectives, advantages and novel features of the present invention will be apparent to one skilled in the art from the following details, and through exercising the invention. While the invention is described below, it should be apparent that the invention is not limited to the specific details described. One skilled in the art, having access to the teachings herein, will recognise additional applications, modifications and incorporations in other areas, which are within the scope of the invention.

### GENERAL DESCRIPTION OF THE DRAWINGS

For a more complete understanding of the present invention and the additional objects and advantages thereof, reference is now made to the following detailed description, which is to be read together with the accompanying drawings, in which the same reference designations pertain to identical parts in the various figures, and in which:

FIG. 1 schematically illustrates a vehicle, according to one embodiment of the invention;

FIG. 2 schematically illustrates a device in the vehicle shown in FIG. 1, according to one embodiment of the invention;

FIG. 3a schematically illustrates a vehicle with presentation elements, according to one embodiment of the invention;

FIG. 3b schematically illustrates a vehicle with presentation elements, according to one embodiment of the invention;

FIG. 3c schematically illustrates a vehicle platoon and a vehicle external to the vehicle platoon, according to one embodiment of the invention;

FIG. 4a schematically illustrates a flow chart of a method, according to one embodiment of the invention;

FIG. 4b schematically illustrates in more detail a flow chart of a method, according to one embodiment of the invention;

FIG. 5 schematically illustrates a computer, according to one embodiment of the invention.

### DETAILED DESCRIPTION OF THE DRAWINGS

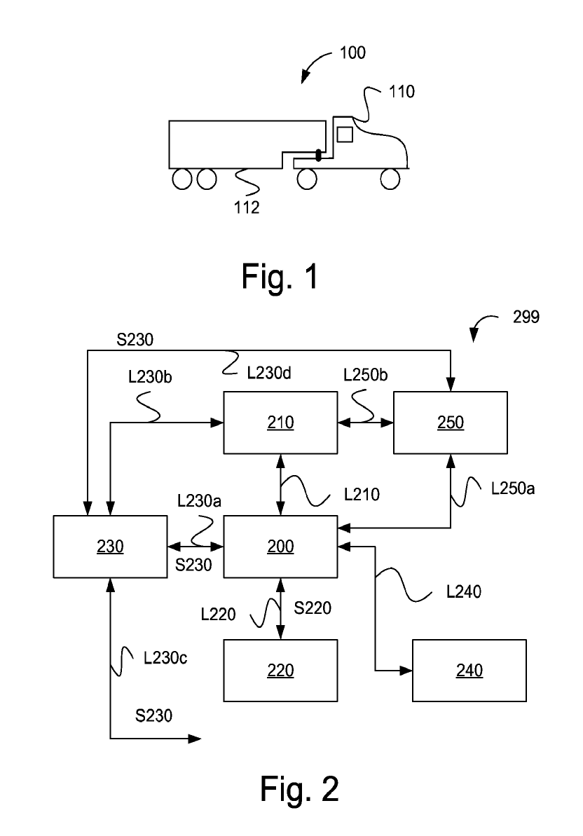

A side view of a vehicle 100 is shown with reference to FIG. 1. The exemplary vehicle 100 comprises a tractor 110 and a trailer 112. The vehicle 100 may alternatively be a truck or a tractor without a trailer or semi-trailer. The vehicle may be a truck with more than one trailer. The vehicle may be any heavy goods vehicle, such as a truck or a bus. Alternatively, the vehicle may be a car.

The term “link” herein refers to a communications link, which may be a physical line such as an optoelectronic communications cable or a non-physical line such as a wireless connection, e.g. a radio or microwave link. Alternatively, said link may comprise radar technology or lidar technology.

The term “vehicle platoon” as used herein refers to a number of vehicles, e.g. trucks, driven one after the other with a distance between them which falls below a predetermined value, e.g. 75 metres, 50 metres, 25 metres or 10 metres. Said distance may be a distance where a reduced reduction of air resistance of a vehicle behind may be obtained. This distance depends, among other things, on the size and shape of the vehicle. A vehicle which is first in said vehicle platoon is called a “leader vehicle” herein. A vehicle platoon may comprise a suitable number of vehicles, e.g. 2, 3, 5 or 10 vehicles. A vehicle platoon may comprise more than 10 vehicles.

With reference to FIG. 2, a device 299 in the vehicle 100 is shown. The device 299 is arranged in the tractor 110 or in another suitable location.

The vehicles 100 forming part of a vehicle platoon may all be equipped with the device 299. A random vehicle may thus be the vehicle that is driven first in the vehicle platoon (leader vehicle) or a subsequent vehicle, i.e. a vehicle that is driven directly following the leader vehicle or further back in the vehicle platoon.

A vehicle that is not a member of said vehicle platoon is, according to one example, equipped with a communications terminal to receive a signal comprising information from a vehicle that is a member of said vehicle platoon. Said information may comprise information about ambient characteristics, driving characteristics and/or vehicle platoon configurations. Said information may comprise an instruction for suitable driving of said vehicle which is not included in said vehicle platoon. Said information may comprise advice regarding whether or not to overtake the vehicle platoon. Said information may comprise instructions for e.g. overtaking the vehicle platoon or regulating the speed of the vehicle which is not included in said vehicle platoon.

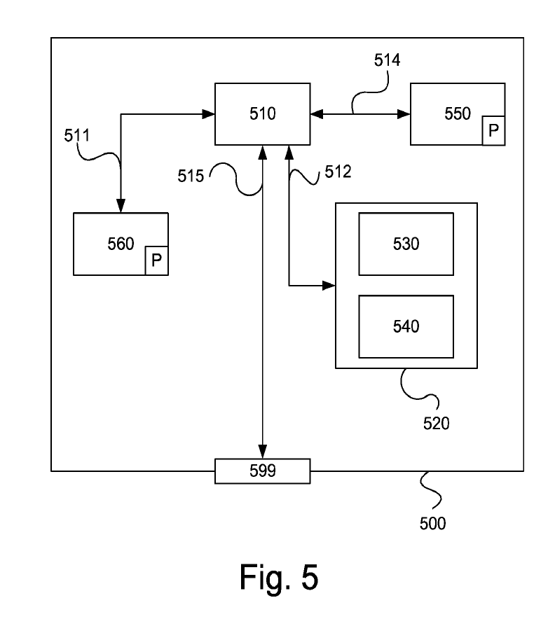

The device 299 comprises a control device 200. The control device 200 comprises electronics and program code, which is described in further detail with reference to FIG. 5.

The control device 200 is arranged, to scan the ambient conditions via suitable elements and determine driving characteristics of said leader vehicle and/or vehicle platoon. The control device 200 is arranged, via suitable elements, to determine the vehicle platoon characteristics. Said vehicle platoon characteristics may comprise information about the number of vehicles forming part of said vehicle platoon. Said vehicle platoon characteristics may comprise information about the length of the vehicle platoon and the mutual distances between the vehicles forming part of the vehicle platoon. Said vehicle platoon characteristics may comprise information about the prevailing speed of the vehicle platoon. Said vehicle platoon characteristics may comprise suitable information about the vehicle platoon's configuration and progress.

The control device 200 is arranged to transfer at least parts of said detected ambient conditions, the determined driving characteristics and the determined vehicle platoon configuration via a wireless communications network common to at least two vehicles, e.g. said leader vehicle and a subsequent vehicle. The control device 200 of a subsequent vehicle may be arranged to forward said transferred information to an additional subsequent vehicle in the vehicle platoon. The control device 200 is adapted to determine a suitable progress in vehicles forming part of the vehicle platoon, based on said ambient conditions and/or said driving characteristics and/or said vehicle platoon configuration. The control device 200 is adapted to determine a suitable progress in vehicles that do not form part of the vehicle platoon, based on said ambient conditions and/or said driving characteristics and/or said vehicle platoon configuration. According to one example embodiment, the control device 200 is adapted to automatically control the progress of said vehicles in the vehicle platoon.

A computer device 210 is arranged for communication with the first control unit 200 via a link L210. The computer device 210 may be detachably connected to the first control device 200. The computer device 210 may be arranged to be supplied with power via an existing battery in the vehicle, such as a 24V battery, which is often installed in heavy goods vehicles today. The computer device 210 may be a control device external to the vehicle 100. The computer device 210 may be a conventional portable computer. The computer device 210 may be arranged to carry out method steps according to the invention. The computer device 210 may be used to transfer software to the control device 200, in particular software to perform the innovative method. Alternatively, the computer device 210 may be arranged for communication with the first control device 200 via an internal network in the vehicle. The computer device 210 may be arranged to carry out essentially similar functions as the first control device 200, such as presenting information, based on information known to the vehicle platoon, to vehicles which do not form part of the vehicle platoon, intended to increase said road safety.

A GPS device 220 is arranged for communication with the control device 200 via a link L220. The GPS device 220 is arranged to continuously determine a prevailing position for the vehicle 100. The GPS device 220 is arranged to continuously determine a prevailing speed for the vehicle 100. The GPS device 220 is arranged to continuously send signals S220, comprising information regarding a prevailing position for the vehicle 100, to the control device 200 via the link L220. Said GPS device may form part of a GNSS (Global Navigation Satellite System). Systems other than GPS may be used, e.g. GLONASS.

The control device 200 is arranged to continuously, via suitable elements, determine information comprising details about the prevailing position, speed, speed changes, direction of travel and/or changes in direction of travel of the vehicle. The control device 200 is arranged to continuously, via suitable elements, determine information comprising details about the prevailing intended speed, intended speed changes, intended direction of travel and/or intended changes in direction of travel of the vehicle. Said information is also called driving characteristics.

Said driving characteristics may be communicated automatically from a leader vehicle to a subsequent vehicle. Thus, a control system of a vehicle behind may obtain said information and automatically control e.g. engine, transmission and/or a brake system based on said information.

The control device 200 is arranged to continuously, via suitable elements, determine information comprising details about ambient conditions. Said ambient conditions may comprise at least one of the parameters traffic situation including risk elements, road characteristics, climate characteristics and road signs.

Said ambient conditions may be communicated automatically from a leader vehicle to a vehicle behind. Thus, a control system of a vehicle behind may obtain said information and automatically control e.g. engine, transmission and/or a brake system based on said information.

Said driving characteristics and said ambient conditions may be communicated from a leader vehicle to a subsequent vehicle in the vehicle platoon essentially simultaneously.

Said driving characteristics may be communicated automatically from a vehicle in the vehicle platoon to a leader vehicle for suitable use.

Said ambient characteristics may be communicated automatically from a vehicle in the vehicle platoon to a leader vehicle for suitable use.

Said driving characteristics and said ambient conditions may be communicated from a vehicle in the vehicle platoon to the leader vehicle essentially simultaneously.

Said leader vehicle may be arranged to communicate directly with more than one vehicle in the vehicle platoon. Said leader vehicle may be arranged to communicate directly with more than one vehicle in the vehicle platoon simultaneously.

A sensor configuration 230 is arranged for communication with the control device 200 via a link L230a. The censor configuration 230 is arranged to continuously detect ambient conditions. The sensor configuration 230 is arranged to continuously determine the driving characteristics of the vehicle. The sensor configuration 230 is arranged to continuously determine the vehicle platoon configuration of the vehicle platoon. The sensor configuration 230 is arranged to continuously generate signals S230, comprising said ambient conditions and/or driving characteristics and/or vehicle platoon configuration of the vehicle platoon. The sensor configuration 230 is arranged to continuously send a signal S230, comprising said information to the control device 200, via the link L230a. The control device 200 is according to one example arranged to send said signal S230 to at least one subsequent vehicle via the communications element 250.

According to one embodiment, the sensor configuration 230 is arranged to continuously send a signal S230 comprising said information to the communications element 250 via a link L230d. The communications element 250 is arranged to forward said signal S230 to at least one subsequent vehicle in the vehicle platoon.

According to one embodiment, the sensor configuration 230 is arranged to continuously send a signal S230 comprising said information directly to a subsequent vehicle via a link L230c.

According to one alternative embodiment said sensor configuration 230 is arranged to send signals S230 from a leader vehicle in real time, comprising said information to the computer 210 via a link L230b. Said sensor configuration 230 is arranged to transfer said information in real time, directly to said computer 210 via the link L230b. Thus, according to this embodiment, no signals S230 comprising said information are sent directly to the control device 200 to be forwarded to at least one subsequent vehicle. Thus, according to this embodiment, no signals S230 comprising said route information are sent directly to said at least one subsequent vehicle.

According to this embodiment the computer 210 is arranged to forward said signals S230 to the communications elements 250 via a link L250b.

Alternatively, the computer 210 is arranged to forward said signals S230 to the communications element 250 via the control device 200, i.e. via the link L210 and a link L250a.

According to an alternative embodiment, said sensor configuration 230 is arranged to transfer said information in real time from a leader vehicle to a subsequent vehicle. Herein, said sensor configuration 230 is arranged to transfer said information in real time to a subsequent vehicle, and/or at least one additional subsequent vehicle. Thus, according to this embodiment, no signals S230 comprising said route information are sent to the control device 200 or to said computer 210 to be forwarded to at least one subsequent vehicle.

The control device 200 is adapted to determine instructions for a vehicle which does not form part of the vehicle platoon, based on said ambient conditions and/or said driving characteristics and/or said vehicle platoon configuration. Said instructions may thus be determined in said leader vehicle or in a vehicle behind in the vehicle platoon.

The control device 200 is adapted to determine a suitable progress in a vehicle driven after the leader vehicle in the vehicle platoon, based on said ambient conditions and/or said driving characteristics and/or said vehicle platoon configuration. The control device 200 is arranged to communicate, in a suitable manner, information about said determined suitable progress to at least one subsequent vehicle in the vehicle platoon. The subsequent vehicles may herein be controlled automatically, based on said determined suitable progress. Said suitable progress may comprise speed, speed changes, direction of travel and/or changes in direction of travel.

According to one embodiment, a control device in a vehicle which is driven behind said leader vehicle in the vehicle platoon is adapted to determine a suitable progress in the vehicle, based on information about said ambient conditions and/or said driving characteristics. Herein, said subsequent vehicles may be controlled automatically, based on said determined suitable progress.

Said sensor configuration 230 may comprise suitable sensors. Said sensor configuration 230 may comprise a suitable number of sensors. Said sensor configuration 230 may comprise a suitable set of different sensors. Said sensor configuration may comprise a camera. Said sensor configuration 230 may be a video camera. Said sensor configuration 230 may be a web camera.

According to one embodiment, said sensor configuration 230 comprises a number of cameras, e.g. video cameras. Said several cameras may be set so that they continuously record different fields of vision in order to detect ambient conditions, which ambient conditions may be transmitted to at least one subsequent vehicle. Said fields of vision may at least partly overlap.

According to one embodiment, said sensor configuration 230 comprises a distance sensor and/or a speed sensor, e.g. a radar device, in order to determine the occurrence of external objects and distances connected therewith, and/or distance changes relating to the vehicle and said object. The radar device may be arranged to continuously determine a distance to a vehicle ahead. Herein, a distance to a vehicle ahead may be set automatically, so that a control system of the vehicle may automatically control the operation of the vehicle, so that a desired distance to a vehicle ahead is maintained.

According to one embodiment, said sensor configuration 230 comprises an ultrasound device to determine the occurrence of external objects and distances connected therewith, and/or distance changes relating to the vehicle and said object. The ultrasound device may be arranged to continuously determine a distance to a vehicle ahead.

According to one embodiment, said sensor configuration 230 comprises a laser light device in order to determine the occurrence of external objects and distances connected therewith, and/or distance change relating to the vehicle and said object. The laser light device may be arranged to continuously determine a distance to a vehicle ahead.

According to one embodiment, said sensor configuration 230 comprises an IR camera to determine the occurrence of external objects and distances connected therewith, and/or changes in distances relating to the vehicle and said object. The IR camera may be arranged to continuously determine a distance to a vehicle ahead.

The control device 200 comprises an analysis program to determine said ambient conditions, based on information detected by said sensor configuration. Said analysis program may be an image processing program.

Said sensor configuration 230 may comprise suitable sensors to determine the driving characteristics. Examples of such sensors may be a steering wheel angle sensor, throttle sensor, brake pedal sensor, speed sensor, etc.

The control device may, based on data detected by said sensor configuration 230, determine said ambient conditions, said driving characteristics and said vehicle platoon configuration.

Presentation devices 240 are arranged for communication with the control device 200 via a link L240. Said presentation elements 240 may comprise a display screen. The presentation elements 240 are arranged to continuously receive transmitted signals S230 comprising said ambient conditions, driving characteristics, vehicle platoon configuration, advice, directions and/or instructions. Said signal s230 may comprise e.g. a video stream from said leader vehicle. The presentation elements 240 may be arranged to show said received video stream in real time in said subsequent vehicle, so that at least one field of vision available in said vehicle in front is continuously made available in said subsequent vehicle, to a driver in a vehicle which does not form part of the vehicle platoon.

According to one embodiment, the presentation elements 240 may be arranged to show several video recordings simultaneously, in different windows of the display screen. The size of the windows for the respective received video streams from the respective fields of vision of said leader vehicles may be set in a suitable manner.

According to the invention, the display device 240 is provided, e.g. placed on a trailer 112 of the vehicle. The presentation elements 240 are arranged to show a stream of pictures in real time, so that at least one field of vision available in the vehicle 100 ahead is made available continuously in the vehicle behind, where others may benefit from this information.

Said presentation element 240 may comprise a detachably connected display screen. Said presentation element 240 may consist of an integrated component in the tractor 110 or the trailer 112.

Said presentation element 240 may comprise speakers to present said information. Said presentation element 240 may present instructions, advice or directions in the form of audio signals or synthesized speech. Said instructions, directions or advice may be determined in a leader vehicle or in a subsequent vehicle in the vehicle platoon. Said instructions may be determined based on said ambient characteristics and/or said driving characteristics and/or the vehicle platoon configurations.

Below is a number of examples of information which may be presented to a vehicle that is not included in the vehicle platoon.

### Example 1

In the event said leader vehicle, with the help of the sensor configuration 230, determines ambient conditions comprising a traffic situation where there is an obstacle on the road ahead, information regarding this obstacle may be presented via the presentation elements 240. The vehicle external to the vehicle platoon may obtain suggestions regarding measures, e.g. changing lanes.

Said traffic situation may entail a certain element of risk, e.g. where road works are determined to be ongoing, road workers moving around on site. Herein, the vehicle external to the vehicle platoon may be given instructions for speed reduction to a suitable speed.

### Example 2

In the event said leader vehicle, through a sensor configuration 230, determines ambient conditions comprising road characteristics comprising information about slippery surfaces, the vehicle external to the vehicle platoon may be given instructions for speed reduction to a suitable speed.

### Example 3

In the event said leader vehicle, through a sensor configuration 230, determines ambient conditions comprising climate characteristics in the form of an ambient temperature below a predetermined temperature level, or in the form of prevailing precipitation of a certain type, or wind speeds exceeding a certain magnitude, the vehicle external to the vehicle platoon may be given instructions for speed reduction to a suitable speed.

### Example 4

In the event said leader vehicle, through a sensor configuration 230, determines ambient conditions comprising road signs or other traffic information, this information may be presented to the vehicle external to the vehicle platoon in a suitable manner.

### Example 5

Herein, information may be presented to the vehicle external to the vehicle platoon, when it intends to position itself between two vehicles in the vehicle platoon. This may be desirable in a traffic situation where the vehicle external to the vehicle platoon joins a road from a slip road. Herein, the vehicle platoon may provide space for the vehicle external to the vehicle platoon to position itself between two vehicles forming part of the vehicle platoon. In connection with this, information may be presented to the vehicle external to the vehicle platoon in a suitable manner, e.g. by green lamps being turned on in the vehicles in the vehicle platoon, between which the vehicle external to the vehicle platoon may position itself. Alternatively, information may be displayed in the form of suitable text messages in at least one vehicle of the vehicle platoon. Said text message may comprise information regarding a distance between the vehicles in the vehicle platoon, where the vehicle external to the vehicle platoon may position itself.

### Example 6

Said information may comprise information about suitable distances between the vehicles in the vehicle platoon. These suitable and mutual distances, respectively, may be determined based on e.g. prevailing road conditions. Unevenness in the speed of the vehicles forming part of the vehicle platoon, or slippery surfaces, should lead to a relatively large mutual distance between the vehicles in the vehicle platoon. Thus an advantageous increased road safety may be achieved.

Below is a number of examples of spoken and/or displayed instructions/messages/warnings which may be presented according to different aspects of the invention.

### Example 7

One instruction for presentation to a driver in a vehicle may be: “You may overtake the vehicle platoon. The length of the vehicle platoon is 150 meters”.

### Example 8

One instruction for presentation to a driver in a vehicle may be: “There are road works 100 metres in front of the vehicle, change lanes to the right and reduce speed to 30 km/h”.

### Example 9

A message for presentation to a driver in a vehicle may be: “Overtaking of vehicle platoons is forbidden”.

### Example 10

A message for presentation to a driver in a vehicle may be: “Wild animals on the road ahead. Stop the vehicle immediately”.

End of examples.

Said communications elements 250 are arranged for communication with the control device 200 via a link L250a. Said communications elements 250 are arranged to receive the signal S230 comprising said information about ambient conditions and/or driving characteristics and/or vehicle platoon configurations and/or advice and/or directions and/or instructions. Said communications elements 250 are arranged to send said signal S230 to at least one subsequent vehicle. The communications elements 250 may, according to one example, be arranged for wireless communication and thus send said information using the standard 802.11 ABGN. The communications elements 250 may, according to one example, be arranged for wireless communication according to 802.11 P.

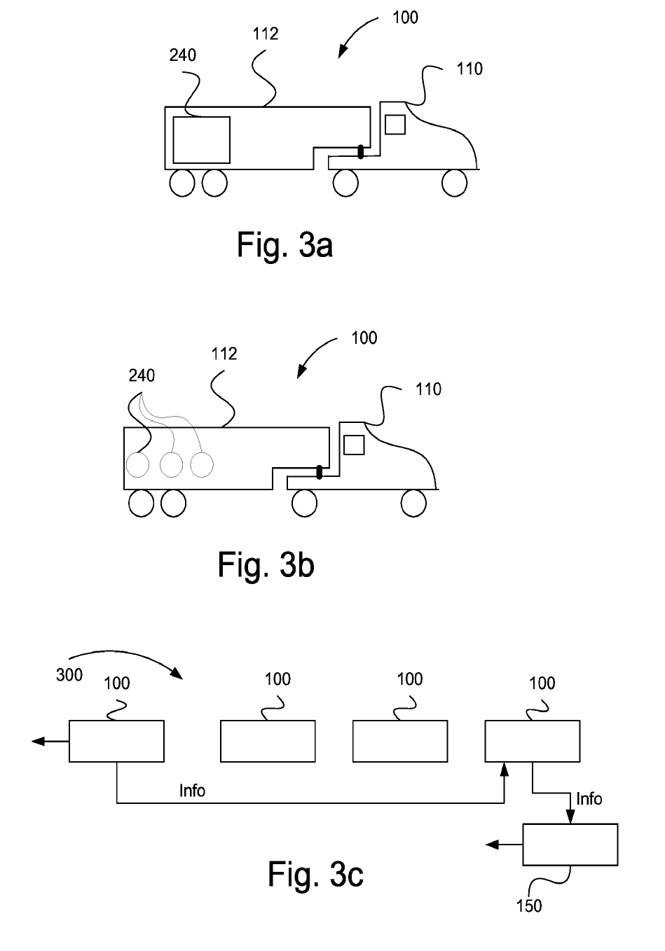

FIG. 3a schematically illustrates a side view of a vehicle equipped with signal devices. Said signal devices may be educated by said presentation element 240.

According to this example embodiment, said signal devices comprise at least one display screen. Said display screen may be arranged in the vehicle in a suitable place.

According to one example embodiment, the vehicle 100 is equipped with three display screens. Herein, a display screen may be provided on the right side of the trailer 112. Herein, a display screen may be provided on the left side of the trailer 112. Herein, a display screen may be provided on a rear side of the trailer 112. Said display screens may have a suitable size.

According to one example, said presentation element 240 may be arranged to show a picture stream in real time, so that at least one vision field available in the leader vehicle 100 is continuously made available to a vehicle that does not form part of the vehicle platoon. Viewing may occur through a presentation element 240 in a suitable vehicle, forming part of the vehicle platoon. The presentation elements 240 are arranged to show a stream of pictures in real time, so that at least one field of vision available in the leader vehicle 100 is made available continuously.

According to one example, a video stream may be displayed where it is apparent that there are obstacles on the road ahead of the leader vehicle 100, and that road signs indicate a temporary passage where reduced speed of the travelling vehicles is required. Thus, the driver of the vehicle forming part of the vehicle platoon may obtain an increased understanding of the traffic and the possibility of taking precautions, such as reducing a prevailing speed by braking to a more suitable speed.

According to one example, a video stream with superimposed information may be displayed, e.g. comprising ambient conditions, driving characteristics, vehicle platoon configurations.

According to one example, a video stream with superimposed information may be displayed, e.g. comprising advice, directions and/or instructions for a vehicle which does not form part of said vehicle platoon.

FIG. 3b schematically illustrates a side view of a vehicle equipped with signal devices. Said signal devices may be educated by said presentation element 240.

According to this example embodiment, said signal devices comprise at least one lamp configuration. Said lamp configuration may be arranged in the vehicle in a suitable place. Said lamp configuration may comprise a suitable set of LEDs, for example. Said lamp configuration may comprise a suitable number of LEDs, which may be arranged to reflect light with a respective predetermined wavelength, e.g. green, yellow or red light.

According to this example embodiment, three lamps 240 are provided on one side of the trailer 112 of the vehicle 100. A first lamp is arranged to show a green light when information is presented. In the event the vehicle is not a leader vehicle, this may indicate that a vehicle which does not form part of the vehicle platoon may overtake the vehicle platoon. In the event the vehicle is a leader vehicle, this may indicate to an operator of a vehicle which does not form part of the vehicle platoon, that the vehicle is de facto a leader vehicle. Herein, an operator of the vehicle, which does not form part of the vehicle platoon, may obtain information that no further vehicles form part of the vehicle platoon ahead of the leader vehicle.

Another lamp is arranged to show a yellow or orange light when information is presented. In the event the vehicle is not a leader vehicle, this may indicate to a driver of a vehicle, which does not form part of the vehicle platoon, the need to consider whether or not he should overtake the vehicle platoon. Alternatively, it may indicate to an operator of a vehicle which does not form part of the vehicle platoon that the vehicle is a vehicle located between a leader vehicle and a vehicle which is the last in the vehicle platoon.

A third lamp is herein arranged to show a red light, when information is presented. In the event the vehicle is not a leader vehicle, this may indicate to a driver of a vehicle which does not form part of the vehicle platoon that he should not overtake the vehicle platoon.

According to one example, a lamp adapted to show different colours may replace or complement the three lamps shown in FIG. 3b.

According to one example embodiment, the vehicle 100 is equipped with three lamp configurations. Herein, a lamp configuration may be provided on the right side of the trailer 112. Herein, a lamp configuration may be provided on the left side of the trailer 112. Herein, a lamp configuration may be provided on the rear side of the trailer 112. Said lamp configuration may have a suitable size.

According to one embodiment of the invention, lamps in vehicles in the vehicle platoon may show where the vehicle platoon begins and ends. A leader vehicle may thus have one or several lamps with a suitable colour, e.g. orange. A vehicle which is the last vehicle in the vehicle platoon may thus have one or several lamps with a suitable colour, e.g. red.

Thus, it may be possible to prevent that vehicles which do not form part of the vehicle platoon unnecessarily intrude between two vehicles in the vehicle platoon. Thus, it may also be possible to distinguish two different vehicle platoons, e.g. when one vehicle platoon is divided into two separate vehicle platoons.

According to one example, dangerous traffic situations may be noticed by drivers of vehicles that do not form part of the vehicle platoon. For example, vehicles in the vehicle platoon would herein continuously have blinking lamps.

FIG. 3c schematically illustrates a vehicle platoon 300, comprising four vehicles 100. Herein, it is illustrated that a leader vehicle determines parameters comprising ambient conditions, driving characteristics and/or vehicle platoon configurations. Said parameters may be sent to a last vehicle in the vehicle platoon 300. Said last vehicle may, in accordance with the method according to the invention, determine information Info, which is to be presented to a vehicle 150 that does not form part of said vehicle platoon. Thus, said determined information is communicated from said last vehicle in the vehicle platoon to said vehicle 150. Thus, said determined information may be presented to an operator of said vehicle 150 via suitable equipment.

According to one alternative, said last vehicle may communicate said determined parameters, where suitable means in said vehicle 150 may determine said information Info, and thereafter present said information Info to an operator of said vehicle 150.

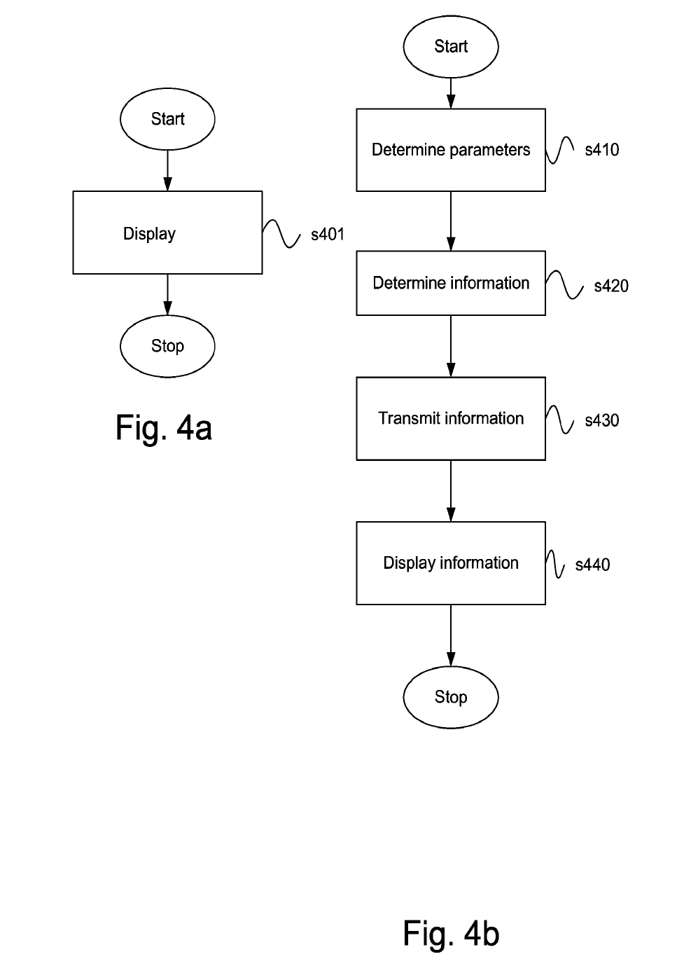

FIG. 4a schematically illustrates a flow chart of a method for increased road safety in vehicle platoons, according to one embodiment of the invention. The method comprises an initial method step s401. Step s401 comprises the step of:
for vehicles that do not form part of the vehicle platoon, and based on information known to the vehicle platoon, present information intended to increase said road safety. The method is completed after step s401.

FIG. 4b schematically illustrates a flow chart of a method for increased road safety in vehicle platoons, according to one embodiment of the invention.

The method comprises an initial method step s410. The method step s410 comprises the step to determine parameters. Said parameters may be determined through a sensor configuration 230 in at least one suitable vehicle of the vehicle platoon. Said parameters may comprise ambient conditions, driving characteristics and/or information about vehicle platoon configurations. Following the method step s410, a subsequent method step s420 is completed.

The method step s420 comprises the step to determine information. Said information may be determined based on said ambient conditions, driving characteristics and/or information about vehicle platoon configurations. Said information may comprise advice, directions or instructions for a driver of a vehicle which is not included in said vehicle platoon. Following the method step s420, a subsequent method step s430 is completed.

The method step s430 comprises the step to transfer said determined information within the vehicle platoon. Said transfer of information may be carried out wirelessly. According to one example, information which is determined by one leader vehicle is transferred from said leader vehicle to a vehicle which is the last vehicle in said vehicle platoon.

According to one embodiment, determined parameters are transferred to at least one vehicle suitable for presentation in said vehicle platoon, from at least one vehicle forming part of the vehicle platoon, e.g. said leader vehicle. Thus, the receiving vehicle of said parameters may determine said information for presentation.

It should be pointed out that said parameters may be determined by a suitable vehicle forming part of said vehicle platoon. Further, a suitable vehicle may determine said information for presentation.

Following the method step s430, a subsequent method step s440 is completed.

The method step s440 comprises the step to present said information to vehicles not forming part of the vehicle platoon. This may occur via said presentation elements 240 in a suitable manner. Said information may be displayed with a suitable duration of information.

It should be pointed out that at least one suitable vehicle in the vehicle platoon may present said information to a vehicle that does not form part of said vehicle platoon.

Following the method step s440, the method is completed.

With reference to FIG. 5, a diagram of an embodiment of device 500 is shown. The control devices 200 and 210, which are described with reference to FIG. 2, may in one embodiment comprise the device 500. The device 500 includes a non-volatile memory 520, a data processing unit 510 and a read/write memory 550. The non-volatile memory 520 has a first memory part 530 wherein a computer program, such as an operative system, is stored to control the function of the device 500. Further, the device 500 includes a bus controller, a serial communications port, an I/O device, an ND converter, a date-time input and transmission unit, an event counter and an interrupt controller (not displayed). The non-volatile memory 520 also has a second memory part 540.

Herein, a computer program P is provided, comprising procedures to achieve increased road safety in vehicle platoons.

The computer program comprises procedures for vehicles which do not form part of the vehicle platoon and to present information, based on information known to the vehicle platoon, intended to increase said road safety. The computer program comprises procedures to determine the phenomena vehicle platoon characteristics, the vehicle's ambient conditions, including traffic situation. The computer program comprises procedures to determine the ambient conditions and/or driving characteristics in vehicle platoons and/or vehicle platoon configurations.

The computer program comprises procedures to determine directions, instructions and/or advice to said vehicles that do not form part of the vehicle platoon, based on at least one of the parameters ambient conditions, driving characteristics, vehicle platoon configurations.

The computer program comprises procedures to control signal devices in order to present information to vehicles that do not form part of said vehicle platoon, via light and/or audio and/or text messages.

The computer program comprises procedures to communicate information wirelessly, for presentation to vehicles which do not form part of the vehicle platoon.

The computer program comprises procedures to determine a time specification, relating to an estimated period of time to overtake the vehicle platoon, for a vehicle that does not form part of said vehicle platoon. The computer program comprises procedures to determine advice regarding whether or not to overtake the vehicle platoon.

The program P may be stored in an executable manner or in a compressed manner in a memory 560 and/or in a read/write memory 550.

A statement that the data processing unit 510 performs a certain function means that the data processing unit 510 performs a certain part of the program which is stored in the memory 560 or a certain part of the program stored in the read/write memory 550.

The data processing unit 510 may communicate with a data port 599 via a data bus 515. The non-volatile memory 520 is intended for communication with the data processing unit 510 via a data bus 512. The separate memory 560 is intended for communication with the data processing unit 510 via a data bus 511. The read/write memory 550 is arranged for communication with the data processing unit 510 via a data bus 514. The links, e.g., L210, L220, L230a, L230b, L240, L250a and L250b may be connected to the data port 599 (see FIG. 2).

When data is received in the data port 599 it is temporarily stored in the second memory part 540. When in-data received is temporarily stored, the data processing unit 510 is ready to carry out execution of code in the manner described above. According to one embodiment, the signals received in the data port 599 comprise information regarding ambient conditions and/or driving characteristics of the vehicle platoon and/or vehicle platoon configurations. The signals received in the data port 599 may be used by the device 500 to present information, based on information known to the vehicle platoon intended to increase said road safety, to vehicles which do not form part of the vehicle platoon.

Parts of the methods described herein may be carried out by the device 500 with the help of the data processing unit 510, which runs the program stored in the memory 560 or in the read/write memory 550. When the device 500 runs the program, the procedures described herein are executed.

The foregoing description of the preferred embodiments of the present invention has been furnished for illustrative and descriptive purposes. It is not intended to be exhaustive, or to limit the invention to the variants described. Many modifications and variations will obviously be apparent to one skilled in the art. The embodiments have been chosen and described in order to best explicate the principles of the invention and its practical applications, and to thereby enable one skilled in the art to understand the invention in terms of its various embodiments and with the various modifications that are applicable to its intended use.

1. Method for increased road safety in vehicle platoons (300),
characterised by the step to:
present (s401; s440) to vehicles (150), which do not form part of the vehicle platoon, and based on information known to the vehicle platoon, information intended to increase said road safety.

2. Method according to claim 1, wherein said presented information comprises at least one of the phenomena vehicle platoon characteristics, vehicle ambient conditions, including traffic situation.

3. Method according to claim 1 or 2, wherein said presented information comprises instructions to said vehicles (150) which do not form part of said vehicle platoon.

4. Method according to any of the previous claims, comprising the step to:
provide signal devices in the vehicle platoon in order to present said information via light and/or audio and/or text messages and/or symbols.

5. Method according to any of the previous claims, comprising the step to:
communicate said information wirelessly (s430) for presentation to vehicles which do not form part of the vehicle platoon (150).

6. Method according to any of the previous claims, wherein the thus presented information comprises a time specification relating to an estimated period of time to overtake the vehicle platoon.

7. Method according to any of the previous claims, wherein said information comprises advice, relating to whether or not to overtake the vehicle platoon.

8. Device for increased road safety of vehicle platoons (300),
characterised by:
elements (240) adapted to present information, based on information known to the vehicle platoon intended to increase said road safety, to vehicles which do not form part of the vehicle platoon.

9. Device according to claim 8, comprising:
elements (200; 210; 230) adapted to determine at least one of the phenomena vehicle characteristics and ambient conditions of the vehicle, including traffic situation, said presented information comprising information regarding said at least one of said phenomena vehicle platoon characteristics and ambient conditions of the vehicle, including traffic situation.

10. Device according to claim 8 or 9, comprising:
elements (200; 210; 230) adapted to determine instructions to said vehicles (150) which do not form part of the vehicle platoon, where said presented information comprises information regarding said instructions to said vehicles which do not form part of the vehicle platoon.

11. Device according to any of claims 8-10, comprising:
signal devices (240) in the vehicle platoon, adapted to present said information via light and/or audio and/or text messages and/or symbols.

12. Device according to any of claims 8-11, comprising:
an element (250) adapted to communicate said information wirelessly for presentation to vehicles which do not form part of the vehicle platoon.

13. Device according to any of claims 8-12, comprising:
elements (200; 210; 230) adapted to determine time specifications regarding an estimated period of time for overtaking the vehicle, where the thus presented information comprises information regarding said time specification regarding an estimated period of time to overtake the vehicle platoon.

14. Device according to any of claims 8-13, comprising:
elements (200; 210; 230) adapted to determine advice regarding whether or not to overtake a vehicle platoon, where said information comprises information about said advice regarding whether or not to overtake the vehicle platoon.

15. Motor vehicle (100), comprising a device according to any of claims 8-14.

16. Computer program (P) for increased road safety in vehicle platoons, wherein said computer program (P) comprises program code to cause an electronic control device (200; 500), or another computer (210; 500) connected to the electronic control device (200; 500), to perform the steps according to any of patent claims 1-7.

17. Computer program product, comprising a program code stored in a computer-readable medium, in order to perform the method steps according to any of claims 1-7, when said program code is executed in an electronic control device (200; 500) or in another computer (210; 500) connected to the electronic control device (200; 500).
